(19) United States
(12) Patent Application Publication
(10) Pub. No.: US 2009/0077254 A1
(43) Pub. Date: Mar. 19, 2009

(54) SYSTEM AND METHOD FOR STREAMED-MEDIA DISTRIBUTION USING A MULTICAST, PEER-TO- PEER NETWORK

(76) Inventors: Thomas Darcie, Victoria (CA); Neil Barakat, Victoria (CA)

Correspondence Address: MALDJIAN & FALLON LLC, 365 BROAD ST. , 3RD FLOOR, RED BANK, NJ, 07701, US

(21) Appl. No.: 12/211,015

(22) Filed: Sep. 15, 2008

Related U.S. Application Data
(60) Provisional application No. 60/972,125, filed on Sep. 13, 2007.

(51) Int. Cl. G06F 15/16

(52) U.S. Cl. 709/231

(57) ABSTRACT

In one embodiment, a system for streamed-media distribution comprises a first media stream received at a streaming server, at least a first and a second client in communication with the streaming server, first and second sub-stream packet streams created from the first media stream at the streaming server, and received by first and second clients, respectively, a first peer-relay list, transmitted from the streaming server and received by the first client, wherein the first peer-relay list includes forwarding information for the first client, a third sub-stream packet stream, forwarded from the first client and received at the second client, wherein the third-sub-stream packet stream is substantially the same as the first sub-stream packet stream, and a notification, transmitted by the second client to the streaming server, if any of the packets in the third sub-stream packet stream are not received in a timely manner from the first client.

### CROSS-REFERENCE TO RELATED APPLICATIONS

This application claims priority to U.S. Patent Application Ser. No. 60/972,125, filed Sep. 13, 2007, entitled “System and Method for Streamed-Media Distribution Using a Multicast, Peer-to-Peer Network,” the disclosure of which is incorporated herein by reference in its entirety.

### BACKGROUND

1. Field of the Invention

Embodiments of the present invention generally relate to a system and method for distributing streamed-media using a multicast, peer-to-peer network. More specifically, embodiments of the present invention relate to a system and method for distributing streamed-media using a multicast, peer-to-peer network to a plurality of users in a network in pseudo-real time.

2. Description of Related Art

In most current commercially deployed media streaming systems, a streaming server transmits one copy of the stream to each client. The bandwidth requirement at the streaming server is therefore roughly equal to the bandwidth required for a single stream (i.e., the stream bitrate) multiplied by the number of clients simultaneously receiving that stream.

In a content distribution network (CDN), the stream service provider distributes the stream to multiple streaming servers in their own network. Each client receives the stream from one of the streaming servers. Usually, the streaming servers are geographically separated, so clients receive improved performance by connecting to the closest streaming server. The cost of the CDN service provider may also be reduced, because the cost of carrying the stream over their own network to a streaming server close to the user may be less than the cost of transmission from a streaming server located far away from the client.

In a CDN, since each streaming server serves a subset of the clients for each stream, the bandwidth requirement of each is lower than it would be if only one streaming server were used. However, the total egress aggregate bandwidth of the CDN is equal to the stream bandwidth multiplied by the total number of users, just as in the single-streaming-server case.

In many peer-to-peer (p2p) streaming systems, clients help with content distribution by transmitting all or part of the stream to other clients, thereby reducing the egress bandwidth requirements of the streaming server(s). Various p2p architectures have been proposed for both file distribution and real-time streaming.

P2P streaming applications can themselves be divided into one-to-one applications, often referred to as unicast applications, and one-to-many applications, often referred to as multicast applications. In the former, one computer communicates directly to another without passing through an intermediate server. Often, such applications are symmetric in that each of the two peering computers transmits an approximately equal amount of traffic to the other. Examples of currently deployed unicast p2p applications include internet telephony or voice-over-IP applications, such as SKYPE®.

There are also many one-to-many p2p streaming architectures that have been deployed for transmitting a media stream from one host computer to multiple other computers. Currently deployed p2p streaming architectures include CoolStreaming, PPLive, GRIDMEDIA®, SplitStream, and ChunkySpread. The BitTorrent protocol is also used for file distribution rather than streaming in some cases, and currently, includes a large number of users.

Peer-to-peer streaming can also be referred to as peer-to-peer multicast because a stream originating in a single server is distributed in pseudo-real time to multiple clients. In peer-to-peer multicast systems, clients connect directly with each other to form an overlay network topology. Packets from the stream are then distributed and shared among clients via this overlay network. Most p2p streaming systems can be categorized into two types based on the structure of their overlay network: tree-based and mesh-based. In a mesh-based p2p multicast system, clients self-organize into a densely connected mesh network overlay topology.

Mesh-based overlay p2p systems are characterized by largely decentralized operation, as each client locates and connects directly with other peering clients. In most cases, clients peer with multiple others to improve resilience to network changes caused as clients join and leave the network. This is commonly referred to by those having skill in the art as “network churn” or “churn.” In a tree-based overlay, peers interconnect in a tree topology. These networks are inherently well suited for streaming applications because the transmission through the tree naturally preserves packet ordering and minimizes bandwidth overhead. The operation of these networks relies on the correctness of the tree topology. Thus, relatively complicated tree maintenance is required to ensure that the tree stays intact when clients leave the network due, for example, to churn or system failure.

In the simplest scenario, each client receives the stream and forwards it to one or more other clients until the leaf-nodes of the tree are reached. In such a system, however, the maximum stream bitrate can be severely restricted by the upstream bandwidth of the clients. This limitation can be combatted by splitting a media stream into multiple sub-streams and transmitting each over a different p2p multicast tree. As long as each client that wishes to receive the stream is a member of each tree, every client will receive sufficient information to reconstruct the entire stream. In general, upstream bandwidth requirements can be minimized by ensuring that each client resides in a branching node of at most one multicast tree.

All of the above p2p streaming systems share the common objective of massive scalability and aim to provide streams to thousands of clients through a single p2p-overlay-network structure. Hand-in-hand with this scalability is the objective of a completely decentralized operation or substantially complete decentralized operation. Peers self-organize into an overlay structure and locate data sources independently. In this way the bandwidth and processing burden traditionally carried by a streaming server is comparable to that of the p2p-overlay clients. Indeed, in most of these systems, the hardware and bandwidth of the steaming source (i.e., the server) may be comparable to that of the client machines that receive and forward the stream.

However, achieving this level of distributed operation comes at the cost of simplicity, both architectural and operational. With no centralized control point, network monitoring is very challenging. It is also challenging to control the so-called quality-of-service received by each client, such as packet loss rate, stream latency, and the like. The self-organizing capability strength from the perspective of network robustness is the very feature that makes it difficult to isolate the source of problems in the network. Also, the completely decentralized nature of the system makes it susceptible to abuse by clients with malicious intents, so security of media-stream content and network integrity may also be quite challenging. For distribution of media streams in a commercial setting, such as a subscription or pay-per-view service, all of the above issues related to monitoring, control, security, and quality of service are very important.

The massive scalability and distributed nature of current p2p streaming systems are partially due to the fact that many are based on their popular p2p file-sharing counterpart. As such, most p2p streaming applications resemble closely p2p file-sharing applications with some added machinery for packet temporal dependencies and packet latency considerations. Current p2p streaming architectures are also largely pull-based, as clients examine which packets they require to reconstruct the stream and then request them explicitly from other clients based on information they have received about what packets their peers currently possess. This approach is very natural for file-based p2p sharing systems. Because of the singularity of the media source and the temporal restrictions of pseudo-real-time media streaming, however, such an approach is somewhat unnatural, as the very topology of the overlay defines largely the flow of information through the network. Further, unlike in a file-sharing network, this flow is predominantly one-way, emanating from the stream source outwards.

Thus, there is a need for an improved system and method for distributing streamed-media using a multicast, peer-to-peer network to a plurality of users in a network in pseudo-real-time.

### SUMMARY OF THE INVENTION

Embodiments of the present invention relate to a system and method for distributing streamed-media using a multicast, peer-to-peer network to a plurality of users in a network in pseudo-real time. In one embodiment of the present invention, a system for streamed-media distribution comprises a first media stream received at a streaming server, at least a first and a second client in communication with the streaming server, first and second sub-stream packet streams created from the first media stream at the streaming server, and received by first and second clients, respectively, a first peer-relay list, transmitted from the streaming server and received by the first client, wherein the first peer-relay list includes forwarding information for the first client, a third sub-stream packet stream, forwarded from the first client and received at the second client, wherein the third-sub-stream packet stream is substantially the same as the first sub-stream packet stream, and a notification, transmitted by the second client to the streaming server, in the event that any of the packets in the third sub-stream packet stream are not received in a timely manner from the first client.

In another embodiment of the present invention, a system for streamed-media distribution comprises a first media stream received at a streaming server, at least a first and a second client in communication with the streaming server, first and second sub-stream packet streams created from the first media stream at the streaming server, and received by first and second clients, respectively, a first peer-relay list, transmitted from said streaming server and received by the first client, wherein the first peer-relay list includes IP addresses for the first client, and wherein the first client forwards substantially the received first sub-stream packet stream to at least the second client, a notification, transmitted by the second client to the streaming server, in the event that any of the packets in the third sub-stream packet stream are not received in a timely manner from the first client, and a fourth sub-stream packet stream, transmitted from either of the streaming server or a third client, to the second client, wherein the fourth sub-stream packet stream comprises any of the packets in the third-sub stream packet stream that are not received in a timely manner from the first client, to the second client.

In another embodiment, a system for streamed-media distribution comprises a first media stream received at a streaming server, at least first, second, and third clients in communication with the streaming server, first, second, and third sub-stream packet streams created from the first media stream at the streaming server, and received by first, second, and third clients, respectively, first, second, and third peer-relay lists, transmitted from said streaming server and received by the first, second, and third clients, respectively, wherein the peer-relay lists include forwarding information for the first, second, and third clients, and wherein the first, second, and third clients forward substantially the received first, second, and third sub-stream packet streams, respectively, to at least one other client, wherein each client sends messages to the streaming server in the event that some or all of the packets in the forwarded substantially first, second, and third sub-stream packet streams are not received in a timely manner from the other clients, and wherein the streaming server transmits the some or all of the packets in the forwarded substantially first, second, and third sub-stream packet streams, that are not received in a timely manner from the other clients, to the first, second, or third client.

In another embodiment, a system for streamed-media distribution comprises a first media stream received at a streaming server, at least first, second, and third clients in communication with the streaming server, first, second, and third sub-stream packet streams created from the first media stream at the streaming server, and received by first, second, and third clients, respectively, first, second, and third peer-relay lists, transmitted from said streaming server and received by the first, second, and third clients, respectively, wherein the peer-relay lists include forwarding information for the first, second, and third clients, and wherein the first, second, and third clients forward substantially the received first, second, and third sub-stream packet streams, respectively, to at least one other client, wherein each client sends messages to the streaming server in the event that some or all of the packets in the forwarded substantially first, second, and third sub-stream packet streams are not received in a timely manner from the other clients, and wherein the streaming server determines, based on messages from the clients, that at least one of the first, second, and third clients in has ceased effective forwarding of the respective sub-stream packet streams, and wherein the streaming server transmits modified peer-relay lists to at least one of the clients.

In another embodiment of the present invention, a system for streamed-media distribution comprises a first media stream received at a streaming server, at least a first and a second client in communication with the streaming server, first and second sub-stream packet streams created from the first media stream at the streaming server, and received by first and second clients, respectively, a first peer-relay list, transmitted from said streaming server and received by the first client, wherein the first peer-relay list includes forwarding information for the first client, and wherein the first client forwards substantially the received first sub-stream packet stream to at least the second client, wherein the second client sends messages to the streaming server in the event that some or all of the packets in the forwarded substantially first sub-stream packet stream are not received in a timely manner from the first client, a third client in communication with the streaming server to request to receive the first media stream, and whereupon receiving the request the streaming server transmits substantially the first media stream to the third client for a initial warm-up period, after which the streaming server transmits a third sub-stream packet stream to the third client, the streaming server transmits a modified peer-relay list to the first client, and the first client first client forwards substantially the received first sub-stream packet stream to at least the third client.

In yet another embodiment, a method for streamed-media distribution comprises receiving a first media stream at a streaming server, creating at the streaming server at least a first and a second sub-stream packet streams from the first media stream, transmitting the at least a first and a second sub-stream packet streams to at least a first and second client, respectively, transmitting from the streaming server to the at least first client a peer-relay list that includes forwarding information for the first client, wherein the first client forwards substantially the received first sub-stream packet stream to at least the second client, and transmitting messages from the second client to the streaming server in the event that any of the packets in the forwarded substantially first sub-stream packet stream are not received in a timely manner from the first client.

### BRIEF DESCRIPTION OF THE DRAWINGS

So the manner in which the above recited features of the present invention can be understood in detail, a more particular description of embodiments of the present invention, briefly summarized above, may be had by reference to embodiments, several of which are illustrated in the appended drawings. It is to be noted, however, the appended drawings illustrate only typical embodiments of embodiments encompassed within the scope of the present invention, and, therefore, are not to be considered limiting, for the present invention may admit to other equally effective embodiments, wherein:

FIG. 1 depicts a block diagram of a general computer system in accordance with one embodiment of the present invention;

FIG. 2 depicts a block diagram of a system in accordance with one embodiment of the present invention;

FIG. 3 depicts a system and the respective data flow for a single sub-stream in a split-broadcast streaming network in accordance with one embodiment of the present invention;

FIG. 4 depicts a system having a full-mesh topology with links between each pair of the n clients and the streaming server in accordance with one embodiment of the present invention; and

FIG. 5 depicts a flow chart of a method of performing split-broadcast streaming in accordance with one embodiment of the present invention.

The headings used herein are for organizational purposes only and are not meant to be used to limit the scope of the description. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures.

### DETAILED DESCRIPTION

Embodiments of the present invention generally relate to a system and method for distributing streamed-media using a multicast, peer-to-peer network. More specifically, embodiments of the present invention relate to a system and method for distributing streamed-media using a multicast, peer-to-peer network to a plurality of users in a network in pseudo-real time.

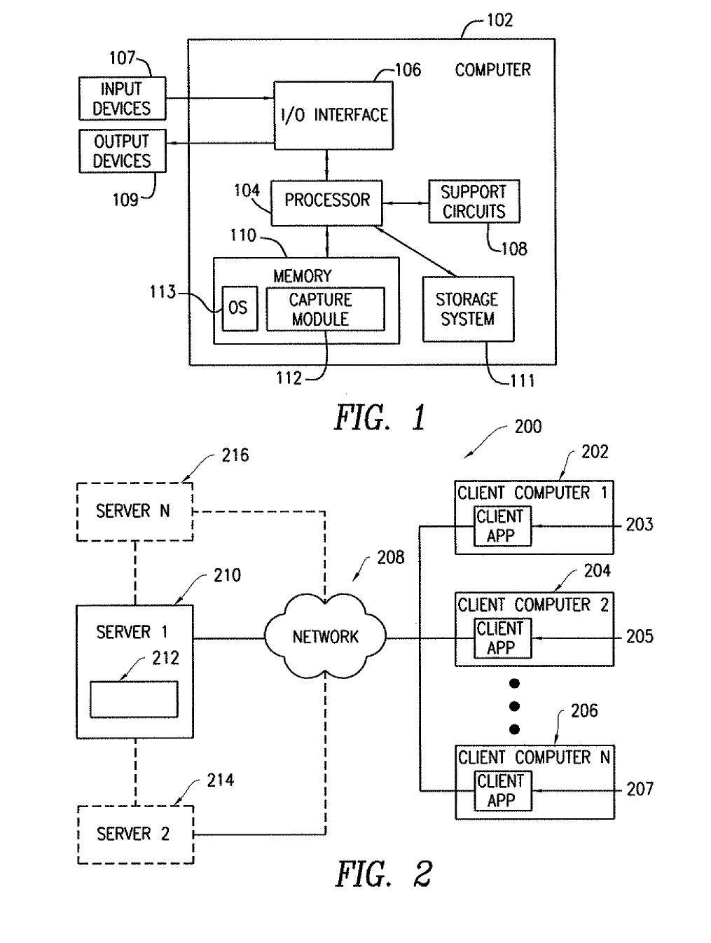

FIG. 1 depicts a block diagram of a general computer system in accordance with one embodiment of the present invention. The computer system 100 generally comprises a computer 102. The computer 102 illustratively comprises a processor 104, a memory 110, various support circuits 108, an I/O interface 106, and a storage system 111. The processor 104 may include one or more microprocessors. The support circuits 108 for the processor 104 include conventional cache, power supplies, clock circuits, data registers, I/O interfaces, and the like. The I/O interface 106 may be directly coupled to the memory 110 or coupled through the processor 104. The I/O interface 106 may also be configured for communication with input devices 107 and/or output devices 109, such as network devices, various storage devices, mouse, keyboard, display, and the like. The storage system 111 may comprise any type of block-based storage device or devices, such as a disk drive system.

The memory 110 stores processor-executable instructions and data that may be executed by and used by the processor 104. These processor-executable instructions may comprise hardware, firmware, software, and the like, or some combination thereof. Modules having processor-executable instructions that are stored in the memory 110 may include a capture module 112. The computer 102 may be programmed with an operating system 113, which may include OS/2, Java Virtual Machine, Linux, Solaris, Unix, HPUX, AIX, Windows, MacOS, among other platforms. At least a portion of the operating system 113 may be stored in the memory 110. The memory 110 may include one or more of the following: random access memory, read only memory, magneto-resistive read/write memory, optical read/write memory, cache memory, magnetic read/write memory, and the like.

FIG. 2 depicts a block diagram of a system in accordance with one embodiment of the present invention. The system 200 generally comprises a first client computer 202, a second client computer 204, and additional client computers, up to client computer N 206, where N represents any number of client computers practical for operation of embodiments of the present invention. The system 200 further includes a network 208, a server 210, a mixer 212, and optionally a plurality of N additional servers, shown here as 214 and 216 in accordance with one embodiment of the present invention. The network 208 may be any network suitable for embodiments of the present invention, including, but not limited to, a global computer network, an internal network, a local-area network, a wireless network, and the like. Mixer 212 is just one representative audio source, and this can be replaced by any other source of audio, video, or mixed media information.

The first client computer 202 comprises a client application 203. The client application 203 is generally software or a similar computer-readable medium capable of at least enabling the first client computer 202 to connect to the proper network 208. In one embodiment, the client application 203 is software, commercially available from Lightspeed Audio Labs of Tinton Falls, N.J. In another embodiment, the client application 203 further provides instructions for various inputs (not shown), both analog and digital, and also provides instructions for various outputs (not shown), including a speaker monitor (not shown) or other output device. The second client computer 204 and client computer N 206 also comprise respective client applications (205, 207). The client applications 203, 205, 207 may be identical, substantially the same or substantially different client applications.

The server 210 may be any type of server, suitable for embodiments of the present invention. In one embodiment, the server 210 is a network-based server located at some remote destination (i.e., a remote server). In another embodiment, the server 210 may be hosted by one or more of the client computers. In yet another embodiment of the present invention, the server 210 is under the control or authority of an internet service provider (ISP) or other provider or entity and is capable of handling the transmission of data by multiple clients at any given time.

The server 210 may also comprise a server application (not shown). The server application may comprise software or a similar computer-readable medium capable of at least allowing clients to connect to a proper network. In one embodiment, the server application is software, commercially available by Lightspeed Audio Labs of Tinton Falls, N.J. Optionally, the server application may comprise instructions for receiving data signals from a plurality of clients, compiling the data signals according to unique parameters, and the like.

The mixer 212 may be any mixing device capable of mixing, merging, or combining a plurality of data signals at any one instance. In one embodiment, the mixer is a generic computer, as depicted in FIG. 1. In another embodiment, the mixer 212 is capable of mixing a plurality of data signals, in accordance with a plurality of different mixing parameters, resulting in various unique mixes. The mixer 212 is generally located at the server 210 in accordance with one embodiment of the present invention. Alternative embodiments provide the mixer 212 is located at a client computer, independent of server location.

As is understood by one of ordinary skill in the art, multiple servers may be the most efficient methods of communication between multiple clients when particular constraints exist. In one embodiment, multiple servers are provided to support multiple clients in a particular session. For example, in one embodiment, a group of three clients are connected through a first server 210 for a first session. A group of five clients want to engage in a second session, but the first server 210 is near capacity. The group of five clients is then connected through the second server 214 to allow for a session to take place.

For example, in accordance with another embodiment, a server 210 hosting a mixer 212 is provided in a system 200. As the server 210 becomes congested with multiple client transmissions, it may be beneficial to allow some of the clients to pass through a second server 214, thus relieving the bandwidth on the server 210. The second server 214 and first server 210 may be connected to one another through the network and/or any other known communication means to provide the most efficient methods of communication. If necessary, additional server N 216, where N represents any number of servers practical for operation of embodiments of the present invention, may be utilized as well.

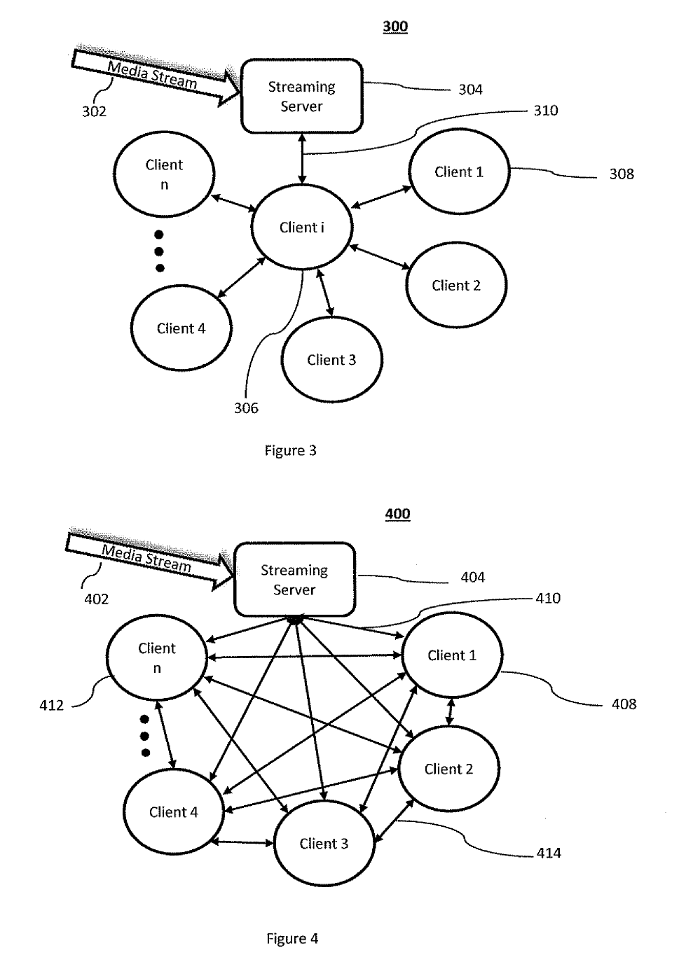

FIG. 3 depicts a system 300 and the respective data flow for a single sub-stream in a split-broadcast streaming (hereinafter “SBS”) network in accordance with one embodiment of the present invention. The media stream 302 to be distributed originates in a stream source (not shown) in the service provider's network. The stream source transmits the media stream 302 to a streaming server 304. In another embodiment, the media stream 302 is transmitted to a plurality of streaming servers 304. The streaming server 304 may reside at the same physical location as the stream source, or the streaming server 304 may be distributed over a large geographical area.

As is shown in FIG. 3, the system 300 also includes a sub-stream 310 transmitted to a client-i 306. The client-i 306 then transmits the sub-stream 310 to at least a first client 308. In one embodiment, the sub-stream 310 is transmitted to a plurality of clients 308 (designated in FIG. 3 as Client 1 through Client n) that constitute a peer group. In one embodiment, the sub-stream 310 transmitted may be configured using a star topology, which may also be referred to as a hub-and-spoke topology. In this accord, client-i 306 lies at the center of the star and other clients lie on the points of the star. The streaming server 304 transmits the sub-stream 310 to client-i 306, who broadcasts it to the other clients, as indicated in FIG. 3. In one embodiment, one such star may be defined for each of the sub-streams 310.

A key aspect of the current invention is the manner in which sub-streams are managed. Streaming server 304 serves a variety of functions, including controlling the admission and removal of a particular client from the peer group, instructing each client which others clients they are to forward to, detecting intentional or unintentional disappearance of a peer group member (user churn), and managing events such as lost packets. These are discussed later in detail. The intent is to create a simple, low latency, and robust method to decrease server bandwidth by a modest amount. This is in contrast to other peer-to-peer approaches that intend to decrease bandwidth substantially, at the expense of complexity and generally with large latency. As such, the streaming server remains solely responsible for or at least actively engaged in the aforementioned functions, in close and direct interaction with the clients.

FIG. 4 depicts a system 400 having a full-mesh topology with links (a) between each client (e.g., Client 1 linked to each of Clients 2 through n, the peer group) and (b) between each individual client and the streaming server 404. The media stream 402 to be distributed originates in a stream source (not shown) in the service provider's network. The stream source transmits the media stream 402 to a streaming server 404. In another embodiment, the media stream 402 is transmitted to a plurality of streaming servers 404. In accordance with one embodiment of the present invention, each client lies at the center of one star and at a point of each other star. In another embodiment, a plurality of clients is present, wherein the client-n 412 represents any number of clients.

The composite overlay topology of the SBS system includes a combination of the stars and therefore may resemble a full-mesh topology with links (a) between each client (e.g., Client 1 linked to each of Clients 2 through n) and (b) between each individual client and the streaming server 404. In one embodiment, there is a one-way media stream 410 flowing between the streaming server 404 and each client, and a two-way media stream 414 flowing between each pair of clients. Again, streaming server 404 manages such aspects as controlling the admission and removal of a particular client from the peer group, instructing each client which others clients they are to forward to, detecting intentional or unintentional disappearance of a peer group member (user churn), and managing events such as lost packets, as discussed later.

In one embodiment of the present invention, a system includes a streaming server that is local to a peer group containing any number of client machines indexed by i=1, 2, . . . , n. Upon receiving the media stream 402, the streaming server divides the stream into any number of sub-streams. The streaming server transmits at least a sub-stream to client i. In another embodiment, the streaming server also provides each client with a peer-relay list, which contains, for example, the IP address of each of the n clients in the peer group. Upon receiving a sub-stream-i packet from the streaming server 404, client i stores the packet and then forwards a copy of it to all of other clients on its peer-relay list. The net result is that each client in the peer group receives all n sub-streams, one sub-stream from the streaming server directly and n−1 sub-streams from the other clients in its peer group. The complete media stream is then reconstructed for playback in each client.

In another embodiment of the present invention, each client that wishes to receive the sub-stream is assigned a local streaming server. Each client is also assigned to a peer group consisting of multiple clients, all of whom share the same local streaming server. In one embodiment, the selection of a local streaming server for each client and the selection of peer groups may be made based on the performance metrics of the media stream, such as the latency between each client and the server or any other parameter feasible in the context of the present invention. In another embodiment, the selection of a local streaming server for each client and the selection of peer groups may be made based on network performance metrics, such as load balancing among streaming servers or any other parameter feasible in the context of the present invention. In yet another embodiment, each streaming server coordinates the transmission of the media stream to each of the peer groups for which it is local.

In one embodiment, the stream source transmits a copy of the entire stream to each of the streaming servers. This transmission can be done via multiple unicast connections between the stream source and streaming servers or by employing any form of multicast transmission, such as a multicast tree with the stream source as the root node. The stream may then be forwarded to all of the clients via split-broadcast streaming.

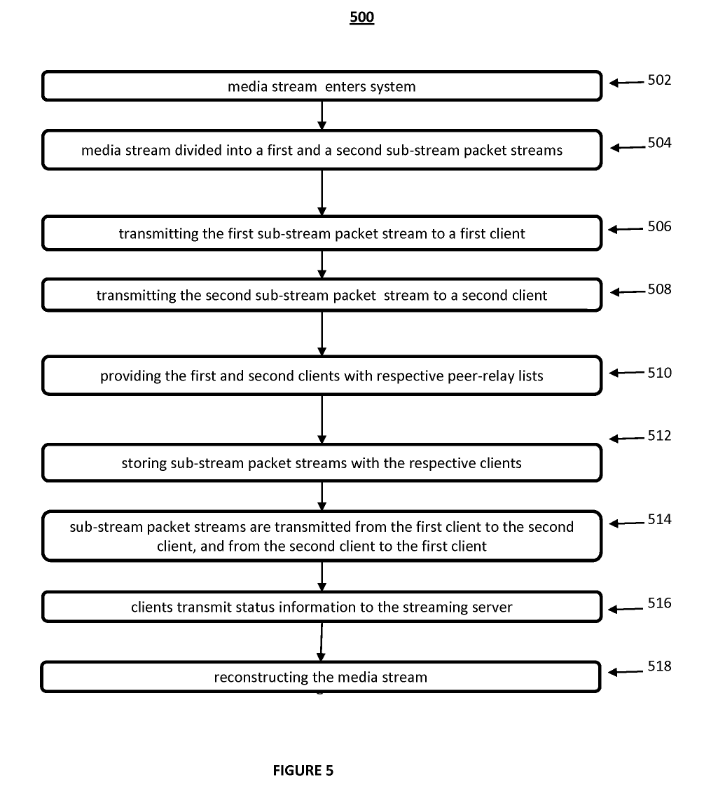

FIG. 5 depicts a flow chart of a method 500 of performing split-broadcast streaming in accordance with one embodiment of the present invention. The method 500 may be utilized with respect to the system 300 disclosed in FIG. 3, the system 400 disclosed in FIG. 4, or any other system consistent with embodiments of the present invention. All descriptions of the processes occurring at any one client described herein are equally intended by embodiments of the present invention to be applicable to any or all additional clients.

The method 500 begins at step 502, in which a media stream is introduced to the system. In accordance with one embodiment of the present invention, the media stream is received at a streaming server. At step 504, the received media stream is divided into at least one sub-stream. In one embodiment of the present invention, the media stream may be divided into at least a first sub-stream and a second sub-stream, up to n-sub-streams, wherein n represents any number of clients in communication with the streaming server. The sub-streams may also be characterized as a sub-stream packet stream.

At step 506, at least a first sub-stream packet stream is transmitted to a first client. At step 508, at least a second sub-stream packet stream is transmitted to a second client. Each of the clients receiving a sub-stream packet stream from the streaming server may be a member or members of a peer group.

At step 510, the first and second clients are provided with a first and second peer-relay list, respectively. In accordance with one embodiment of the present invention, the peer-relay lists contain information associated with the identity of members of the peer group to which each client is to forward copies of their received sub-streams, which may include, but is not limited to, IP addresses of each of the members. At step 512, the clients may store at least the respective sub-stream packets. The clients may store the sub-stream packets for any length of time. In many embodiments of the present invention, transmission or forwarding of any sub-stream packet occurs instantaneously, less nominal latency and/or transmission delays, wherein the time may be characterized as real-time or pseudo real-time.

At step 514, sub-stream packet streams are transmitted from the first client to the second client, and from the second client to the first client. These streams are substantially the same as the streams received by each respective client from the streaming server in 506 ands 508. In accordance with one embodiment of the present invention, these streams may be an exact duplicate or a substantial copy of the first (or second) sub-stream packet streams. At step 516, the clients may transmit status information to the streaming server. Examples of this status information include a number corresponding to a packet that is has not been received by the client in step 514, but that is required to reconstruct the media stream. In response, the server transmits the missing packet directly to the requesting client. Also, based on aggregate information collected at the streaming server, the streaming server may adjust the peer-relay lists, which are then retransmitted to the clients. Given now the complete packet sequence, at step 518, the media stream is reconstructed at each client from, for the example of the second client, the information sent directly from the streaming server in 508, the information forwarded from the first client, and any missing packets re-sent from the streaming server, whereby the reconstructed media stream is substantially identical to the initial media stream.

In one embodiment of the present invention, the media stream in the streaming server is divided into n sub-streams for transmission to the clients, wherein “n” represents any number of clients in communication with the streaming server. In this accord, there are many different manners in which a media stream can be divided into sub-streams. In one embodiment of the present invention, regardless of which method of dividing the media stream into the sub-stream is used, the media stream may be reconstructed in the clients from the n sub-streams.

In one embodiment of the present invention, the streaming server can utilize a “round-robin” type scheduler to create sub-streams. For example, if one out of n sub-stream packets from the media stream is transmitted to each of i clients, then n sub-streams will be created, each having a bitrate equal to 1/n of the media stream bitrate. In another embodiment of the present invention, a weighted round-robin scheduler can be used to create n sub-streams of equal or unequal bitrate. For example, by transmitting mᵢ out of every m packets to client i, where m=m₁+M₂+ . . . +mₙ, the system would generate n sub-streams, where the bitrate of the i^{th} sub-stream is equal to mᵢ/m of the media-stream bitrate. In another embodiment of the present invention, the selection of the bitrate of each sub-stream could be determined based on network performance metrics, such as the available upstream and downstream bandwidth at each of the clients, the reliability of clients, or any other property feasible in the context of the present invention. For example, larger portions of the media stream may be transmitted to more reliable clients for broadcasting to other clients.

In accordance with another embodiment of the present invention, the streaming server may process arriving media stream packets to create code-based sub-streams. In one embodiment, such a system might be implemented in the application layer of the streaming server. For example, an audio media stream could be divided into multiple sub-streams in the frequency domain, rather than the time domain, by first transforming the audio stream into a frequency-domain representation, such as with a Fourier transform, and then transmitting the coefficients of a subset of frequencies in each sub-stream. Alternatively, in one of many other embodiments, multiple-description coding or layered coding could be used to divide the media stream into n sub-streams.

In one embodiment, depending on how the sub-streams are created, some resilience to packet loss and user churn can be realized by adding some dependencies and redundancies between sub-streams. In this accord, one such situation might comprise creating n/2 unique sub-streams and transmitting two copies of each of them to the n clients. Accordingly, if each client receives two copies of each sub-stream, the system may be more resilient to packet loss. In another embodiment, packet-level forward-error correction (FEC) could be used. In this case, the media stream would be divided into n-m unique media streams and m redundancy packets. If any n-m of the sub-streams are received by a client, the media stream may be reconstructed. In another embodiment, an erasure code or some similar technique could be used to introduce redundancy in the sub-streams such that reception of only a subset of them at a client is sufficient for media-stream reconstruction.

In accordance with one embodiment of the present invention, in a network where clients are identical, each sub-stream may be statistically identical. For example, in such an embodiment, the clients may have the same bandwidth. However, in other embodiments, many practical systems having different clients may have different performance limitations. For these systems, it may be prudent to divide the media stream into non-identically-sized sub-streams. In this case, the bandwidth of the sub-stream received from the streaming server and copied and transmitted to all other clients may differ. However, each client still receives all sub-streams, one from the streaming server and the rest from the other clients, so the total received bitrate is still equal to that of a single complete media stream.

In accordance with another embodiment of the present invention, upon entering the SBS system, each client may conduct a series of performance tests. The performance tests could measure the latency between clients or between the clients and the streaming server. Such latency tests may be used to determine peer-group membership, as it may be advantageous to construct peer groups among clients that are closest together. In another embodiment, these tests may also measure the maximum available downstream and upstream transmission rates of the client. This information could then be used by the streaming server to create a sub-stream for each client that has a bitrate below that of the maximum client bandwidth. In one embodiment, the streaming server divides the media stream into sub-streams with different bandwidths according to the bandwidth limitations of each client. In another embodiment, the reliability of a client and the probability of the client departing the peer group prematurely, inferred from past statistics, for example, may also be used to determine the sub-stream size transmitted from the streaming server to each client. In particular, more reliable clients could be charged with the task of forwarding larger-sized sub-streams, which may be subject to their maximum bandwidth constraint.

In one embodiment of the present invention, client operation is configured such that a client-i receives stream-i from the streaming server and copies it to the rest of the clients in the peer group. This can be accomplished by storing the address information of all clients in the peer group in a peer list in each client. In another embodiment, a client receives a packet from the streaming server and stores the packet for later playback, and then forwards a copy of the packet to each of the other clients on the peer list. For example, when a packet arrives from another client, it may be stored for future playback.

In one embodiment, each client receives an identical peer list directly from the server. Alternatively, the server may send the peer list to a subset of clients who then transmit it to one or more other clients, based on, for example, the contents of the peer list. In another embodiment, the only knowledge that the client may require about the network topology and peer-list membership may be contained in the peer list. In another embodiment, each client receives a peer list from the server, but the lists sent to each client differ in some regard. For a trivial example, the list sent to user j may be exclusive of client j. For a more complex example, there may be more members of a peer group that there are sub-streams. In this case, each client may receive a unique list, to which to forward their received sub stream. In accordance with one embodiment, and as described further in the description herein, the streaming server may coordinate the actions of all clients by appropriately modifying their peer lists, which may simplify the operation of the clients.

In another embodiment of the present invention, re-sequencing of packets may be required before media-stream playback may occur. This may be due to the fact that packet arrival times depend on the transmission latencies between clients. Furthermore, because of loss and network churn, some packet copies may be lost and may never arrive to one or more clients. In one embodiment, the client may therefore request for a retransmission of these packets, either from the streaming server or from another client. Under certain conditions, for simplicity, stability, and to minimize the overall time or latency required to recreate a media stream, re-transmission from the media server may be preferred. In accordance with yet another embodiment, since the playback of the media stream is near real-time, all packets, including retransmitted packets must arrive before their playback deadline.

In another embodiment of the present invention, each client maintains two buffers: a resequencing buffer and a playback buffer. In this accord, when sub-stream packets arrive, either from the streaming server or another client, they are inserted into the resequencing buffer. Packets may then be read out from the resequencing buffer according to their sequence numbers and inserted into the playback buffer at the media stream rate. Furthermore, packets may be read out from the playback buffer at the media stream rate and the media stream may be played out on the client machine.

In accordance with another embodiment, missing packets, which may include sequence numbers, may be discovered at a resequencing-buffer-readout time. Accordingly, at this point, the client may either ignore the missing packet or packets or the client may transmit a retransmission request for the missing packet or packets. In the latter case, a retransmission request for the missing packets may be sent directly to the streaming server or to one of the peer-list clients. In accordance with one embodiment, when retransmitted packet or packets arrive at the client, they are inserted directly into the playback buffer in the correct location according to the packets'sequence numbers.

In accordance with one embodiment, the occupancy of the resequencing buffer is directly related to the retransmission timeout of the system. In this accord, retransmission requests may be triggered for any packet that does not arrive within a time duration approximately equal to b_{rsq}Δₘₛ, where b_{rsq} is the resequencing buffer length and Δₘₛ is the average playback duration of each media stream packet. In another embodiment, the occupancy of the playback buffer may implicitly define the maximum amount of latency and jitter of the retransmitted packets.

In any transmission network, there is a non-zero probability of packet loss, so some media stream packets may be unavailable at playback time. Packets may also be unavailable at playback time if they experience excessive delay in transit to the receiving client machine. A missing packet or missing packets can result in playback error or quality degradation in the media stream that is perceivable to the application user.

There are many methods for dealing with or correcting situations involving missing packets. In one embodiment, redundancy may be added to the media sub-streams created in the media server, such as, for example, by using a packet forward-error correction technique. This may make the system resilient to a certain amount of packet loss without affecting quality of the played-back media. However, there may be a tradeoff between the amount of bandwidth overhead introduced in the sub-streams and the amount of packet loss that can be tolerated. In one embodiment, for finite overhead, there may be a maximum amount of loss above which alternative techniques for dealing with missing packets may be required.

In another embodiment of the present invention, the client may send a request for missing packets to be retransmitted. Accordingly, this request may be sent to any machine that possesses the missing packet, which may include the streaming server or another client. Since the media stream cannot be played back until the retransmitted packet arrives, this may impose additional delays on the playback of the media stream in that client. In one embodiment, such approaches may require that the playback of all packets is sufficiently delayed in order to accommodate for the retransmission duration of missing packets.

In yet another embodiment of the present invention, missing packets may be dealt with at playback time by applying an appropriate error concealment technique on the media stream. In one embodiment, these techniques may perform some type of interpolation on the received packets to construct a reasonable approximate of the missing packets' content. In another embodiment, these techniques may perform some type of extrapolation on the received packets to determine the approximate content of future packets if no future packets are available. In either embodiment, the goal is to create a media stream that either resembles as closely as possible the original or to make the effect of missing packets as imperceptible as possible to the listener/watcher of the media stream.

In accordance with another embodiment, any or all of the above techniques may be applied in the SBS system to combat the negative effects of packet loss and packet delay in the system.

In accordance with one embodiment of the present invention, each SBS client is associated with a local streaming server. The clients that are local to a streaming server may be divided into one or more peering groups. Each peer group may be associated with one or more media streams. The streaming server decides on peer-group membership and is in charge of adding and removing clients to peer groups as clients enter and leave the system. One having ordinary skill in the art will recognize this phenomenon as “user churn.” In this accord, the streaming server may communicate changes to the peer-group memberships, possibly in the form of a peer list, to clients either directly, using the same channel through which the media stream is transmitted or an independent channel, or indirectly through other clients. Upon receiving the changes, the client may update its peer list accordingly. In this embodiment, peer-group creation and user churn may be accommodated in SBS by low complexity in the streaming server and clients.

In accordance with one embodiment, adding or removing a client from a peer-group may be implemented in the server in two main steps. In the first step, the sub-stream process is modified to increase or decrease the number of sub-streams by one when a client is added or removed, respectively. In the second step, the peer lists are modified to add or remove the client, and this modification is communicated to all of the peers in the peer group. These two exemplary steps may be characterized as “arrival churn” and “departure churn,” respectively.

In accordance with one embodiment of the present invention, arrival churn may include the process of a client entering into the system, wherein the client is first transmitted the media stream directly from the streaming server for a warm-up period. In this accord, after a time threshold, the new client is added to an appropriate peer group from which to receive the stream.

In another embodiment, the client is first transmitted the entire media stream directly from the streaming server for a finite warm-up period. This warm-up period can be any duration of time. In this accord, a time duration of zero implies that the client joins a peer group immediately. In another embodiment, the warm-up duration may be determined in advance, and may be identical for all clients. Alternatively, in another embodiment, the warm-up duration may be determined on the fly based on past observations of the clients' past behavioral statistics or any other system parameter or parameters feasible in the context of the present invention.

In one embodiment, the warm-up period may allow for the SBS system to efficiently accommodate a client's so-called “rapid scanning” through available media streams before settling on one for a long duration. This may be characterized as “channel-surfing” behavior. In accordance with this embodiment, the accommodation first ensures that the client receives the media stream with minimal delay, which makes it possible to change from one media stream to another rapidly. Second, if the client changes from one media stream to another after a short duration, the warm-up period ensures that the associated peer groups do not need to be updated after such a change. This may reduce the signaling overhead in the network and the computational complexity in the streaming server. One having ordinary skill in the art may find that there is often a non-negligible computation required in order to set up a peer-to-peer connection between two clients. For example, if either is behind a router or firewall that performs network-address-translation (NAT), a NAT traversal technique (e.g., STUN) may be required to initiate a connection between them. In accordance with one embodiment, the use of a warm-up period may therefore also reduce the computational burden associated with setting up direct peering connections between the channel-surfing client and all of the clients in each media stream's peer group.

In accordance with one embodiment of the present invention, after the warm-up period, the newly arrived client may be added to a peer group for a particular media stream. In accordance with one embodiment of the present invention, adding a newly arrived client to a peer group may be accomplished in a number of steps. First, when a warm-up period timeout expires, the local server and peer group for the new client are selected. Then, the streaming server adds the new client's IP address to the peer lists. In the third step, the new peer lists are communicated to all clients in the peer group. Next, direct peer-to-peer connections are established between the new client and all other clients in the peer group. Then, the new client begins to receive sub-streams from all peers. The streaming server then updates the splitting procedure to generate an additional sub-stream which is transmitted to the new client. Finally, the new client, possessing the peer list, begins to receive and forward its sub-stream to all other clients.

In accordance with one embodiment of the present invention, a client may depart the SBS system either by gracefully exiting the system, in which case an explicit notification message is transmitted to the streaming server, or without explicit notification, for example, if the client's power or network connection is severed abruptly. Either of these cases may be characterized as departure churn. In the latter case, the streaming server requires a mechanism for implicitly detecting that the client has left the peering group. In one embodiment, all clients request missing media stream packets directly from the streaming server so that the streaming server may implicitly detect when a user leaves abruptly (i.e., when the user “churns out”) because it will receive retransmission requests from all of the other clients for the departed client's sub-stream's packets. In another embodiment, clients may also send “keep-alive” messages to the streaming server periodically to indicate that they are still part of the peering group. The use of such messages, however, consumes additional bandwidth in the network. Depending on the frequency of these keep-alive messages, there may also be a significant time delay before the client's departure is detected.

In one embodiment, when a client leaves an SBS peer group, the server and other clients may react in a specified manner. Initially, the departed client's missing sub-stream at each client triggers retransmission requests, if required. The streaming server then detects, either explicitly or implicitly, the departure of client. The streaming server then modifies the splitting operation to create one less sub-stream, so no sub-stream is sent from the server directly to the departed client. The streaming server then updates the peer lists, which are communicated to all remaining clients in the peer group. A peer list is updated in all clients, at which point the departed client no longer receives media sub-stream packets from other clients. Finally, the direct peer-to-peer connection between the departed client and other clients is closed. In accordance with one embodiment of the present invention, no retransmission may be required if there is sufficient redundancy between the media sub-streams.

In accordance with one embodiment of the present invention, the peer-to-peer connections to the departed client are explicitly closed. In another embodiment, these connections may be left open until they timeout and are closed automatically, such as by the client machine's operating system. This approach may allow for the departed client to rejoin more efficiently in the case that its departure was only temporary, such as, for example, due to a short duration network outage.

In accordance with one embodiment of the present invention, the streaming server is primarily responsible for keeping track of and updating the peer-group lists and communicating these changes to all clients. In another embodiment, the streaming server is also responsible for negotiating peer-to-peer connections in the case when a third-party machine (i.e., not behind a network-address translator) is required. In alternate embodiments, some of this functionality may be distributed to the client machines.

In accordance with one embodiment of the present invention, control information may be communicated in a separate control channel between the server and clients, which may be more reliable than other configurations. Alternatively, in one of many other embodiments, the control information could be embedded in the data sub-streams in order to save bandwidth in the streaming server. In this accord, by embedding control information into multiple sub-streams, possibly redundantly, the system may experience an increased robustness to client churn and packet loss.

In accordance with one embodiment of the present invention, clients could be called upon to coordinate and implement some of the control functions of the SBS topology maintenance. For example, a client not behind a NAT could be used to negotiate a peer-to-peer connection between other clients. In one embodiment, retransmission requests for missing or late packets are sent directly to the streaming server. In another embodiment, clients may send requests to other clients that may have received the missing packets.

In accordance with one embodiment, the task of providing a warm-up stream may also be assigned to a client machine. In this accord, the streaming server may instruct one of the clients that received the requested media stream to forward the entire stream to the newly-arrived client. In another embodiment, clients in the warm-up stage could forward the media stream to other clients in the warm-up stage. This may prove to be successful since their upstream bandwidth may be otherwise unused.

In accordance with one embodiment of the present invention, when a large number of clients wish to receive the same media stream from the same local streaming server, the streaming server may construct a single peer group comprising all of the clients. However, there may be a practical limitation to the maximum number of clients that are permitted in a single peer group due to, for example, practical limitations on minimum sub-stream granularity and maximum transmission latency. Accordingly, there may be instances when it would be advantageous to create multiple sub-stream peer groups to supply a single media stream to a group of clients. In one embodiment, each parallel peer group would operate independently and in parallel to distribute the media stream to its corresponding members. In another embodiment, the parallel peer groups may have limited interaction in order to improve performance. For example, since clients in both peer groups receive the same media stream, clients in one group may be responsible for responding to packet retransmission requests from clients of the other group. This may not only reduce the burden in the streaming server, but may also provide more robust protection from packet loss due to client churn.

In accordance with one embodiment of the present invention, each client in a peer group receives every sub-stream—one from the streaming server and the rest from its peers. In another embodiment, each client may receive only a subset of sub-streams. There are many reasons for this configuration, including, for example, limited downstream bandwidth availability in the client. If some form of rate-adaptive coding technique, such as multiple description coding, is used for sub-stream creation, these clients may still be able to playback the media stream, albeit at reduced quality. In accordance with another embodiment, this approach could be implemented by having the streaming server communicate non-identical peer lists to each client.

While the foregoing is directed to embodiments of the present invention, other and further embodiments of the invention may be devised without departing from the basic scope thereof. Similarly, embodiments of the present invention are further scalable to allow for additional clients and servers, as particular applications may require.

What is claimed is:

1. A system for streamed-media distribution comprising:
a first media stream received at a streaming server;
at least a first and a second client in communication with the streaming server;
first and second sub-stream packet streams created from the first media stream at the streaming server, and received by first and second clients, respectively;
a first peer-relay list, transmitted from the streaming server and received by the first client, wherein the first peer-relay list includes forwarding information for the first client;
a third sub-stream packet stream, forwarded from the first client and received at the second client, wherein the third-sub-stream packet stream is substantially the same as the first sub-stream packet stream; and
a notification, transmitted by the second client to the streaming server, in the event that any of the packets in the third sub-stream packet stream are not received in a timely manner from the first client.

2. The system of claim 1, further comprising a fourth sub-stream packet stream, transmitted from either of the streaming server or a third client, to the second client, wherein the fourth sub-stream packet stream comprises any of the packets in the third-sub stream packet stream that are not received in a timely manner from the first client, to the second client.

3. The system of claim 2, wherein a media stream substantially identical to the first media stream is reconstructed at the second client from at least the first, second, third and fourth sub-stream packet streams.

4. The system of claim 1, wherein the forwarding information includes IP addresses.

5. A system for streamed-media distribution comprising:
a first media stream received at a streaming server;
at least a first and a second client in communication with the streaming server;
first and second sub-stream packet streams created from the first media stream at the streaming server, and received by first and second clients, respectively;
a first peer-relay list, transmitted from said streaming server and received by the first client, wherein the first peer-relay list includes IP addresses for the first client, and wherein the first client forwards substantially the received first sub-stream packet stream to at least the second client;
a notification, transmitted by the second client to the streaming server, in the event that any of the packets in the third sub-stream packet stream are not received in a timely manner from the first client; and
a fourth sub-stream packet stream, transmitted from either of the streaming server or a third client, to the second client, wherein the fourth sub-stream packet stream comprises any of the packets in the third-sub stream packet stream that are not received in a timely manner from the first client, to the second client.

6. The system of claim 5, wherein a media stream substantially identical to the first media stream is reconstructed at the second client from at least the first, second, third and fourth sub-stream packet streams.

7. The system of claim 5, wherein the streamed media distribution occurs in substantially real-time.

8. A system for streamed-media distribution comprising:
a first media stream received at a streaming server;
at least first, second, and third clients in communication with the streaming server;
first, second, and third sub-stream packet streams created from the first media stream at the streaming server, and received by first, second, and third clients, respectively;
first, second, and third peer-relay lists, transmitted from said streaming server and received by the first, second, and third clients, respectively, wherein the peer-relay lists include forwarding information for the first, second, and third clients, and wherein the first, second, and third clients forward substantially the received first, second, and third sub-stream packet streams, respectively, to at least one other client;
wherein each client sends messages to the streaming server in the event that some or all of the packets in the forwarded substantially first, second, and third sub-stream packet streams are not received in a timely manner from the other clients; and
wherein the streaming server transmits the some or all of the packets in the forwarded substantially first, second, and third sub-stream packet streams, that are not received in a timely manner from the other clients, to the first, second, or third client.

9. A system for streamed-media distribution comprising:
a first media stream received at a streaming server;
at least first, second, and third clients in communication with the streaming server;
first, second, and third sub-stream packet streams created from the first media stream at the streaming server, and received by first, second, and third clients, respectively;
first, second, and third peer-relay lists, transmitted from said streaming server and received by the first, second, and third clients, respectively, wherein the peer-relay lists include forwarding information for the first, second, and third clients, and wherein the first, second, and third clients forward substantially the received first, second, and third sub-stream packet streams, respectively, to at least one other client;
wherein each client sends messages to the streaming server in the event that some or all of the packets in the forwarded substantially first, second, and third sub-stream packet streams are not received in a timely manner from the other clients, and;
wherein the streaming server determines, based on messages from the clients, that at least one of the first, second, and third clients in has ceased effective forwarding of the respective sub-stream packet streams, and;
wherein the streaming server transmits modified peer-relay lists to at least one of the clients.

10. The system of claim 9, wherein the streaming server transmits the some or all of the packets in the forwarded substantially first, second, and third sub-stream packet streams, that are not received in a timely manner from the other clients, to the first, second, or third client.

11. The system of claim 9, wherein the substantially received first, second, and third sub-stream packet streams are forwarded in near real time.

12. The system of claim 9, wherein the peer relay lists comprise IP addresses.

13. The system of claim 9, wherein the combined first, second, and third sub-stream packet streams substantially comprise the first media stream.

14. A system for streamed-media distribution comprising:
a first media stream received at a streaming server;
at least a first and a second client in communication with the streaming server;
first and second sub-stream packet streams created from the first media stream at the streaming server, and received by first and second clients, respectively;
a first peer-relay list, transmitted from said streaming server and received by the first client, wherein the first peer-relay list includes forwarding information for the first client, and wherein the first client forwards substantially the received first sub-stream packet stream to at least the second client;
wherein the second client sends messages to the streaming server in the event that some or all of the packets in the forwarded substantially first sub-stream packet stream are not received in a timely manner from the first client;
a third client in communication with the streaming server to request to receive the first media stream; and
whereupon receiving the request the streaming server transmits substantially the first media stream to the third client for a initial warm-up period, after which the streaming server transmits a third sub-stream packet stream to the third client, the streaming server transmits a modified peer-relay list to the first client, and the first client first client forwards substantially the received first sub-stream packet stream to at least the third client.

15. The system of claim 14, wherein the warm up period is selected to substantially reduce the number of messages received at the streaming server from user churn.

16. The system of claim 14, wherein the modified peer-relay list sent to the first client includes address information for the third client.

17. A method for streamed-media distribution comprising:
receiving a first media stream at a streaming server;
creating at the streaming server at least a first and a second sub-stream packet streams from the first media stream;
transmitting the at least a first and a second sub-stream packet streams to at least a first and second client, respectively;
transmitting from the streaming server to the at least first client a peer-relay list that includes forwarding information for the first client, wherein the first client forwards substantially the received first sub-stream packet stream to at least the second client; and
transmitting messages from the second client to the streaming server in the event that any of the packets in the forwarded substantially first sub-stream packet stream are not received in a timely manner from the first client.

18. The method of claim 17, further comprising transmitting additional sub-stream packet streams from either of the streaming server or a third client, to the second client, wherein the additional sub-stream packet streams comprise any of the packets in the forwarded substantially first-sub stream packet stream, not received in a timely manner from the first client.

19. The method of claim 18, further comprising reconstructing a media stream substantially identical to the first media stream at the second client from at least the first, second, and additional sub-stream packet streams.

20. The method of claim 19, wherein the forwarding information includes IP addresses.
